(19) United States
(12) Patent Application Publication
(10) Pub. No.: US 2015/0070550 A1
(43) Pub. Date: Mar. 12, 2015

(54) SPATIAL BINNING METHOD FOR RE-SAMPLING BINNED IMAGE, RELATED CIRCUIT, AND COMPUTER READABLE MEDIUM

(71) Applicant: Himax Imaging, Inc., Grand Cayman (KY)

(72) Inventor: Miaohong Shi, Grand Cayman (KY)

(73) Assignee: Himax Imaging, Inc., Grand Cayman (KY)

(21) Appl. No.: 14/020,910

(22) Filed: Sep. 9, 2013

(51) Int. Cl. H04N 5/347

(52) U.S. Cl. CPC H04N 5/347
USPC 348/303

(57) ABSTRACT

A spatial binning method for re-sampling a binned image generated by pixel binning includes at least the following steps: receiving a raw image; pixel binning the raw image to generate a binned image; and re-sampling the binned image spatially to generate a re-sampled image according to the values and positions of the pixels of the binned image. A spatial binning circuit, comprising: a binning unit for receiving a raw image to generate a binned image; and a re-sampling unit for receiving the binned image and re-sampling the pixels of the binned image according to the values and positions of the pixels of the binned image.

### BACKGROUND OF THE INVENTION

1. Field of the Invention

The disclosed embodiments of the present invention relate to processing pixel data of an image, and more particularly, to a spatial binning method for re-sampling an image generated by pixel binning, related apparatus, and computer readable medium thereof.

2. Description of the Prior Art

Generally speaking, pixel binning refers to the combination of the information of adjacent detectors in a CMOS image sensor (CIS) or a charge-coupled device (CCD) to create one single pixel in the recorded image. For instance, a 2×2 binning gathers the electrons from a square of four detectors to record them in just one of the image pixels. Thus, the intensity per pixel increases in a factor of (about) four. Different pixel binning methods are used to sum the signals from more pixels to enhance the sensitivity and improve the signal-to-noise ratio (SNR).

Therefore, there is a need for an innovative re-sampling scheme which is capable of restoring the relative pixel distances and compensating the spatial non-uniformity of the binned pixels for improving the image quality.

### SUMMARY OF THE INVENTION

In accordance with exemplary embodiments of the present invention, a spatial binning method for re-sampling a binned image, related apparatus, and computer readable medium thereof are proposed to solve the aforesaid problems.

According to a first aspect of the present invention, an exemplary spatial binning method for re-sampling a binned image is disclosed. The exemplary spatial binning method includes: receiving a raw image; pixel binning the raw image to generate a binned image; and re-sampling the binned image spatially to generate a re-sampled image according to the values and positions of the pixels of the binned image.

According to a second aspect of the present invention, an exemplary spatial binning circuit for re-sampling a binned image is disclosed. The exemplary spatial binning circuit includes: a binning unit and a re-sampling unit, wherein the binning unit is arranged for receiving a raw image to generate a binned image; and the re-sampling unit is arranged for receiving the binned image and re-sampling the pixels of the binned image according to the values and positions of the pixels of the binned image.

According to a third aspect of the present invention, an exemplary non-transitory computer readable medium, storing a program code, wherein when the program code is executed by a processor, the processor performs following steps for spatial binning: pixel binning a raw image to generate a binned image; and re-sampling the binned image spatially to generate a re-sampled image according to the values and positions of the pixels of the binned image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a spatial binning method according to an exemplary embodiment of the present invention.

FIG. 2 is a diagram illustrating operation of the spatial binning method according to an embodiment of the present invention.

FIG. 3 is a diagram illustrating operation of the spatial binning method according to another embodiment of the present invention.

FIG. 4A is a diagram illustrating a pixel block according to an embodiment of the present invention.

FIG. 4B is a diagram illustrating a binned pixel block derived from the pixel block shown in FIG. 4A.

FIG. 4C is a diagram illustrating a re-sampled pixel block derived from the binned pixel block shown in FIG. 4B.

FIG. 5A is a diagram illustrating a pixel block according to another embodiment of the present invention.

FIG. 5B is a diagram illustrating a binned pixel block derived from the pixel block shown in FIG. 5A.

FIG. 5C is a diagram illustrating a re-sampled pixel block derived from the binned pixel block shown in FIG. 5B.

FIG. 6 is a diagram illustrating a spatial binning circuit according to a first embodiment of the present invention.

FIG. 7 is a diagram illustrating a spatial binning circuit according to a second embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

Some of the conventional binning methods introduce side effects. Specifically, the relative pixel distances are changed and the pixel distribution is not uniform after said binning processes, and thus color artifacts and edge zipper effects emerge. The main concept of the present invention is to restore the relative pixel distances and compensate for the spatial non-uniformity of the binned pixels for improving the image quality. In other words, the present invention proposes a spatial binning method for re-sampling an image generated by pixel binning, related apparatus, and computer readable medium according to the corresponding pixel binning algorithm adopted for generating the image.

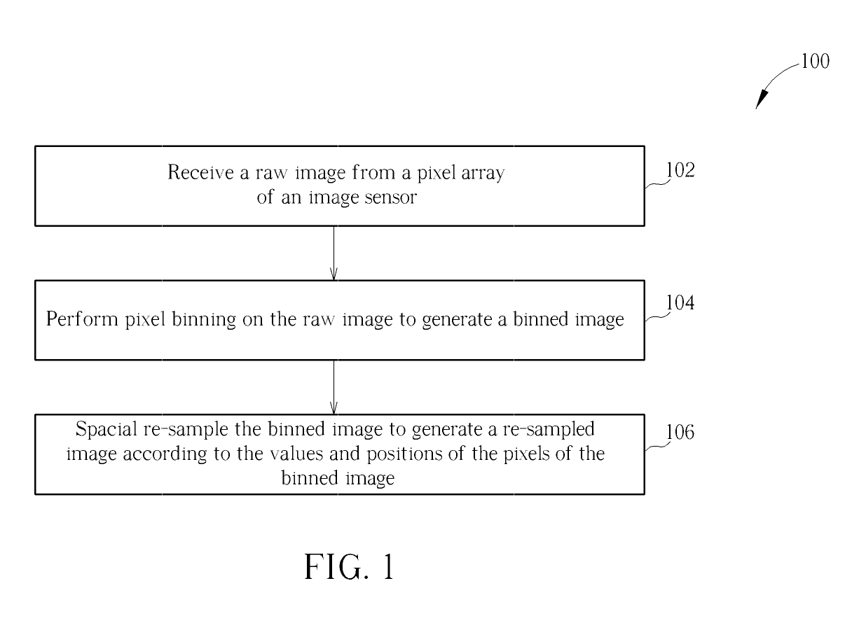

FIG. 1 is a flowchart illustrating a spatial binning method 100 according to an exemplary embodiment of the present invention. Provided that substantially the same result is achieved, the steps in FIG. 1 need not be in the exact order shown and need not be contiguous, that is, other steps can be intermediate. Besides, some steps in FIG. 1 may be omitted according to various types of embodiments or requirements. In this embodiment, the detailed operation for spatial binning a binned image generated by pixel binning may comprise following steps.

Step 102: Receive a raw image from a pixel array of an image sensor;

Step 104: Perform pixel binning on the raw image to generate a binned image; and

Step 106: Spacial re-sample the binned image to generate a re-sampled image according to the values and positions of the pixels of the binned image.

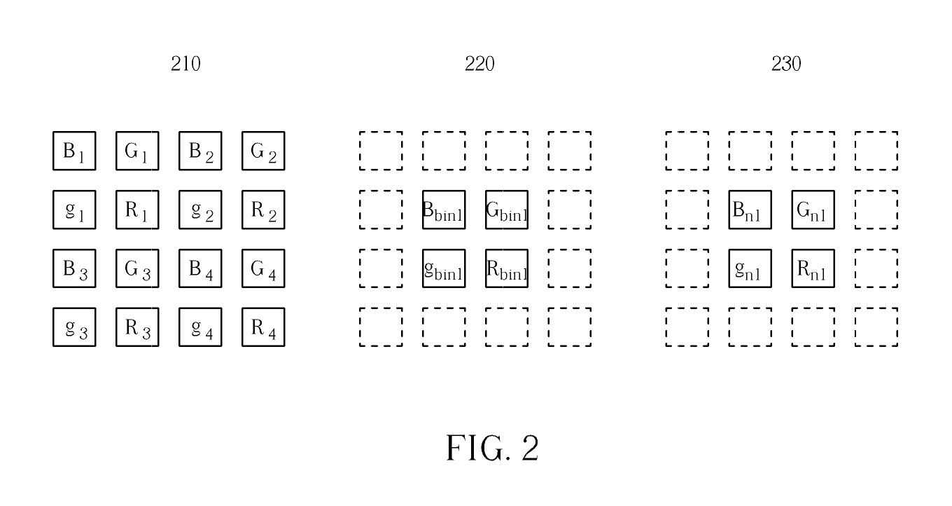

FIG. 2 is a diagram illustrating operation of the spatial binning method according to an embodiment of the present invention. First, a raw image is received shown as the pixel block 210 shown in FIG. 2. Pixel block 210 is for example a 4×4 pixel block including 16 pixels belonging to 3 colors, blue (B), green (G, g) and red (R) arranged according to the Bayer filter. Bayer filter is a color filter array (CFA) for arranging RGB color filters on an array of photo-sensors, wherein the filter pattern is 50% green, 25% red and 25% blue, hence is also called RGBg, GRgB, or RGgB. Then, pixel binning is performed to generate a binned image shown as the binned pixel block 220 shown in FIG. 2. The binned pixel block 220 is a 2×2 pixel block which is generated by vertical binning and horizontal binning, also known as the normal binning. Please note that the boxes with a dotted line are used for illustration of relative positions of the raw image. Specifically, the position of Bbin1 is relatively at the center of B1, B2, B3 and B4; the position of Gbin1 is relatively at the center of G1, G2, G3 and G4; the position of gbin1 is relatively at the center of g1, g2, g3 and g4; and the position of Rbin1 is relatively at the center of R1, R2, R3 and R4.

The values of the binned pixel block 220 are:

B_{bin1}=(B₁+B₂+B₃+B₄)/4,

G_{bin1}=(G₁+G₂+G₃+G₄)/4, g_{bin1}=(g₁+g₂+g₃+g₄)/4, and R_{bin1}=(R₁+R₂+R₃+R₄)/4.

The G_{bin1} pixel and the g_{bin1} pixel are both green, and have a ¼ part overlapping with each other, that is, g2 is positioned in the area formed by G1, G2, G3, and G4; and G3 is positioned in the area formed by g1, g2, g3 and g4. To put it another way, the compositions of the G_{bin1} pixel and the g_{bin1} pixel might interfere with each other (i.e., the ¼ parts which overlap with each other), thus a re-sampling step is performed to compensate for the green part (i.e., G and g) of the normal binning. That is to say, when the binned image is generated by the pixel binning algorithm configured to perform vertical binning and horizontal binning, the binned pixels diagonally adjacent to each other are selected for a same color. The proposed re-sampling step of the embodiment may be expressed using the following equations:

$${B}_{n 1} - {B}_{bi n 1} , \\ {G}_{n 1} = \frac{5}{4} {G}_{bin 1} - \frac{1}{4} {g}_{bin 1} , \\ {g}_{n 1} = \frac{5}{4} {g}_{bin 1} - \frac{1}{4} {G}_{bin 1} , and$$

$${R}_{n 1} = {R}_{bin 1} .$$

A re-sampled pixel block 230 shown in FIG. 2 is a 2×2 pixel block which is generated by re-sampling the binned pixel block 220. The Bₙ₁, Gₙ₁, gₙ₁, and Rₙ₁ are the re-sampling pixels of the binning pixels B_{bin1}, G_{bin1}, g_{bin1}, and R_{bin1}, wherein the Bₙ₁ pixel and the Rₙ₁ pixel are identical to the B_{bin1} pixel and the R_{bin1} pixel, respectively; only the Gₙ₁ pixel and the gₙ₁ pixel are modified. The G_{bin1} pixel and the g_{bin1} pixel are strengthened by a weighting factor 5/4, respectively, and at the same time, a part of g_{bin1} and G_{bin1} (i.e., with a weighting factor ¼) are deducted from the 5/4 G_{bin1} and the 5/4 g_{bin1} respectively to obtain re-sampled pixels without interference between green colors. It should be noted that the weighting factors could be adjusted according to the actual demand in practice. Besides, the settings in this embodiment are for illustrative purposes only, and are not meant to be limitations of the present invention. Hence, modifications on the weighting factors also belong to the scope of the present invention.

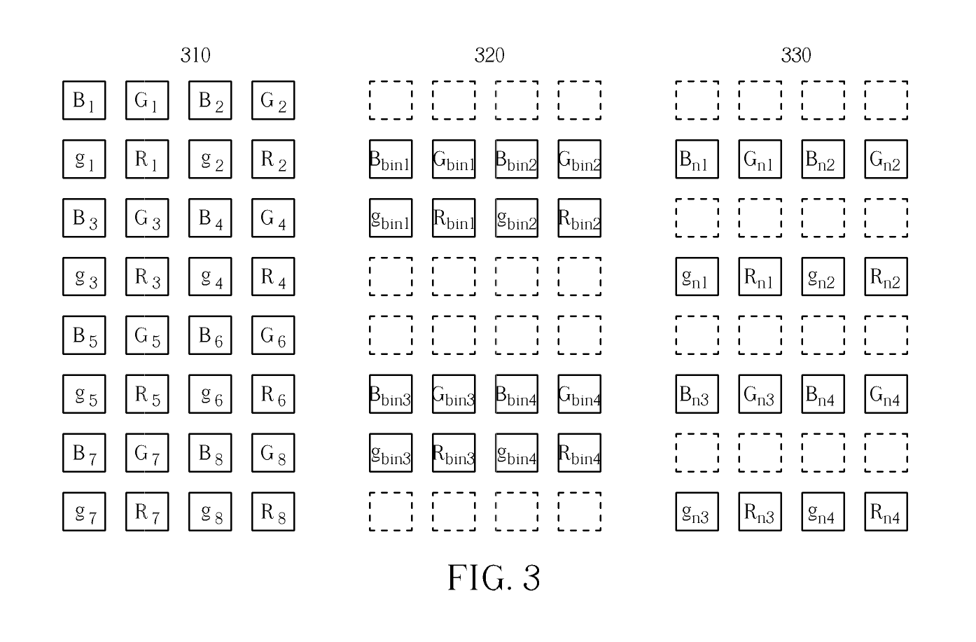

FIG. 3 is a diagram illustrating operation of the spatial binning method according to another embodiment of the present invention. A pixel block 310 shown in FIG. 3 is an 8×4 pixel block including 32 pixels belonging to 3 colors, blue (B), green (G), and red (R) according to the Bayer filter. A binned pixel block 320 shown in FIG. 3 is a 4×4 pixel block which is generated by the pixel binning algorithm configured to perform vertical binning without horizontal binning. Please note that the boxes with a dotted line are used for illustrative purposes only. In other words, the boxes with a dotted line are not pixels due to the 8×4 pixel block being reduced to the 4×4 block after the vertical binning without horizontal binning process. The binned pixels are respectively positioned at the center of the related pixels in the raw image. Specifically, B_{bin1}=(B₁+B₃)/2, G_{bin1}=(G₁+G₃)/2, g_{bin1}=(g₁+g₃)/2, and R_{bin1}=(R₁+R₃)/2.

As other binned pixels in the binned pixel block 320 are generated according to the same rules like B_{bin1}, G_{bin1}, g_{bin1}, and R_{bin1}, the equations of the other binned pixels in the binned pixel block 320 are omitted here for brevity. According the binned pixel block 320, two groups are separated by 8 dotted boxes. More specifically, the relative pixel distance between the g_{bin1} pixel and the B_{bin3} pixel is 3 times as large as the relative pixel distance between the g_{bin1} pixel and the B_{bin1} pixel, and the relative pixel distance between the R_{bin1} pixel and the G_{bin3} pixel is 3 times as large as the relative pixel distance between the R_{bin1} pixel and the G_{bin1} pixel, and so on. To put it another way, the relative pixel distances are changed and the pixel distribution is not uniform after the vertical binning without horizontal binning process. In order to get rid of the side effects and to improve the image quality, the g_{bin1}, R_{bin1}, g_{bin2}, R_{bin2}, g_{bin3}, R_{bin3}, g_{bin4}, and R_{bin4} pixels need to be re-sampled to ensure the uniform distribution of the image. The operation can be expressed using the following equations:

$${B}_{n 1} = {B}_{bin 1} , \\ {G}_{n 1} = {G}_{bin 1} , \\ {g}_{n 1} = \frac{3}{4} {g}_{bin 1} + \frac{1}{4} {g}_{bin 3} , and$$

$${R}_{n 1} = \frac{3}{4} {R}_{bin 1} + \frac{1}{4} {R}_{bin 3} .$$

A re-sampled pixel block 330 shown in FIG. 3 is a 4×4 pixel block which is generated by re-sampling the binned pixel block 320. Please note that the boxes with a dotted line are used for illustrative purposes only, in other words, the boxes with a dotted line are not pixels. The Bₙ₁, Gₙ₁, gₙ₁, and Rₙ₁ are the re-sampling pixels of the binning pixels B_{bin1}, G_{bin1}, g_{bin1}, and R_{bin1}, wherein the Bₙ₁ pixel and the Gₙ₁ pixel are identical to the B_{bin1} pixel and the G_{bin1} pixel, respectively; only the gₙ₁ pixel and the Rₙ₁ pixel are modified. The position of the gₙ₁ pixel is the box with a dotted line right below the g_{bin1} pixel of the binned pixel block 320, and therefore the relative pixel distance between the gₙ₁ pixel and the Bₙ₃ pixel equals the relative pixel distance between the gₙ₁ pixel and the Bₙ₁ pixel. However, the corresponding composition of the gₙ₁ pixel at the position (i.e., the box with a dotted line right below the g_{bin1} pixel of the binned pixel block 320) includes both g_{bn1} and g_{bn3}, and the weighting factor should be ¾ and ¼ respectively due to the relative pixel distance between the gₙ₁ pixel and the g_{bin3} pixel is 3 times as large as the relative pixel distance between the gₙ₁ pixel and the g_{bin1} pixel. That is, the weighting factor of the g_{bin1} pixel should be 3 times as large as the weighting factor of the g_{bin3} pixel, inversely proportional to the distances. Furthermore, the summation of the weighting factor of the g_{bin1} pixel and the weighting factor of the g_{bin3} pixel should be equal to 1 due to that the composition of gₙ₁ contains only g_{bin1} and g_{bin3}. It should be noted that the weighting factors could be adjusted according to the actual demand in practice. Besides, the settings in this embodiment are for illustrative purposes only, and are not meant to be limitations of the present invention. Modifications on the weighting factors also belong to the scope of the present invention.

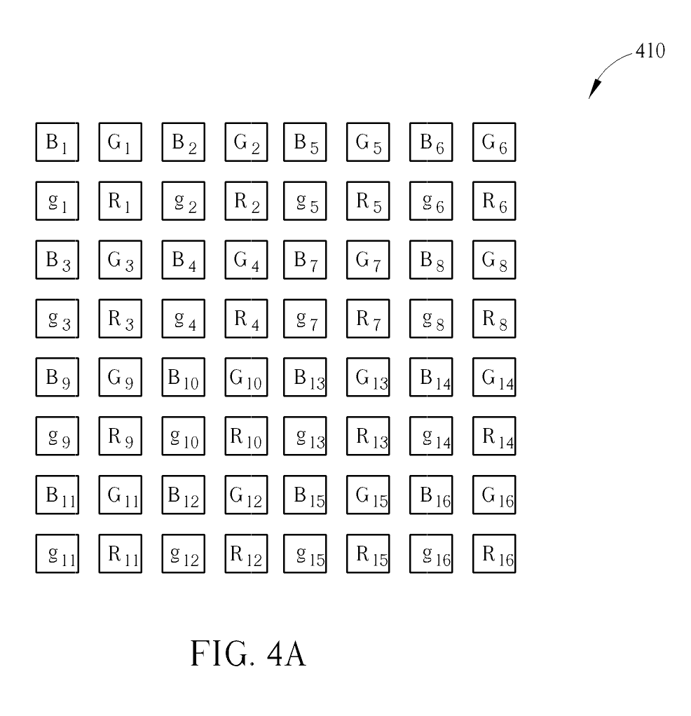

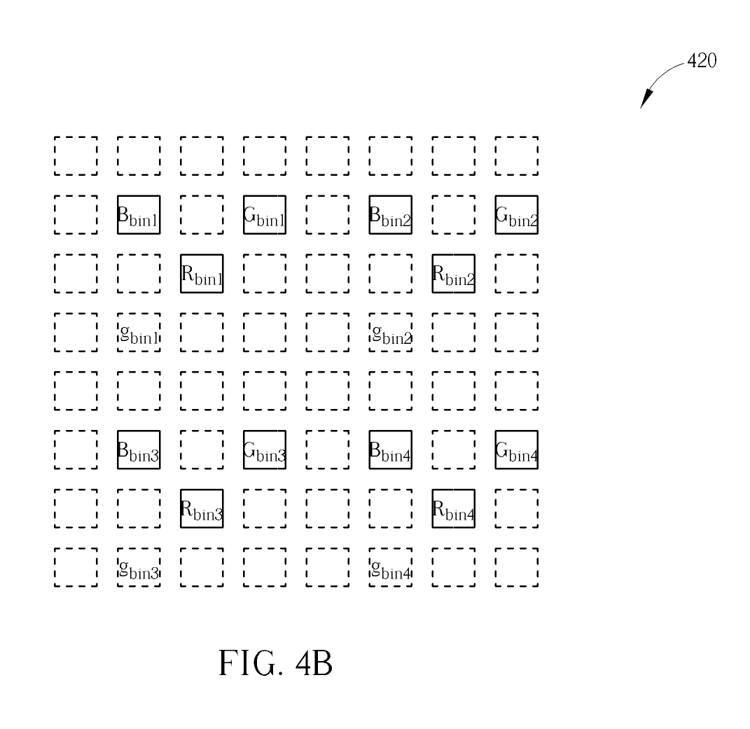

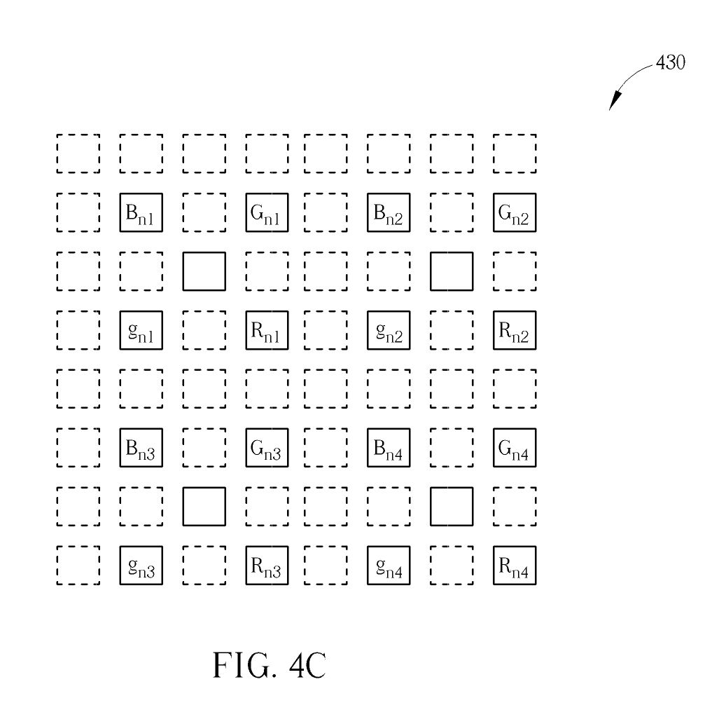

FIGS. 4A-4C are diagrams illustrating a pixel block according to an embodiment of the present invention. The pixel block 410 shown in FIG. 4A is an 8×8 pixel block including 64 pixels belonging to 3 colors, blue (B), green (G), and red (R) according to the Bayer filter. FIG. 4B is a diagram illustrating a binned pixel block derived from the pixel block 410 shown in FIG. 4A. The binned pixel block 420 shown in FIG. 4B is a 4×4 pixel block which is generated by the pixel binning algorithm configured to perform diamond-shape binning. Please note that the boxes with a dotted line are used for illustrative purposes. In other words, the boxes with a dotted line are not pixels due to the 8×8 pixel block 410 being reduced to the 4×4 block 420 after the diamond-shape binning process. The pixels in the binned pixel block 420 might be represented by the following equations:

B_{bin1}=(B₁+B₂+B₃+B₄)/4,

G_{bin1}=(G₂+g₂+G₄+g₅)/4,

g_{bin1}=(G₃+g₃+G₉+g₄)/4, and

R_{bin1}=(R₁+R₂+R₃+R₄)/4.

As other binned pixels in the binned pixel block 520 are generated according to the same rules like B_{bin1}, G_{bin1}, g_{bin1}, and R_{bin1}, the equations of other binned pixels in the binned pixel block 420 are omitted here for brevity.

According the binned pixel block 420, the G_{bin1} pixel and the g_{bin1} pixel no longer overlap with each other like the G_{bin1} pixel and the g_{bin1} pixel in the binned pixel block 220 shown in FIG. 2 due to the diamond-shape binning type of the composition of the G_{bin1} pixel and the g_{bin1} pixel. However, the relative pixel distances are changed and the pixel distribution is not uniform after the diamond-shape binning process. In order to get rid of the side effects and to improve the image quality, the R_{bin1} pixel needs to be moved to another place to ensure the uniform distribution of the image. That is to say, when the binned image is generated by the pixel binning algorithm configured to perform diamond-shape binning, the binned pixels, each vertically adjacent to one of the binned pixels for a same color, horizontally adjacent to another of the binned pixels for the same color, and diagonally adjacent to yet another of the binned pixels for the same color are selected. The related operation may be expressed using the following equations:

$${B}_{n 1} = {B}_{bin 1} , \\ {G}_{n 1} = {G}_{bin 1} , \\ {g}_{n 1} = {g}_{bin 1} , and$$

$${R}_{n 1} = \frac{9}{16} {R}_{bin 1} + \frac{3}{16} {R}_{bin 2} + \frac{3}{16} + \frac{1}{16} {R}_{bin 4} .$$

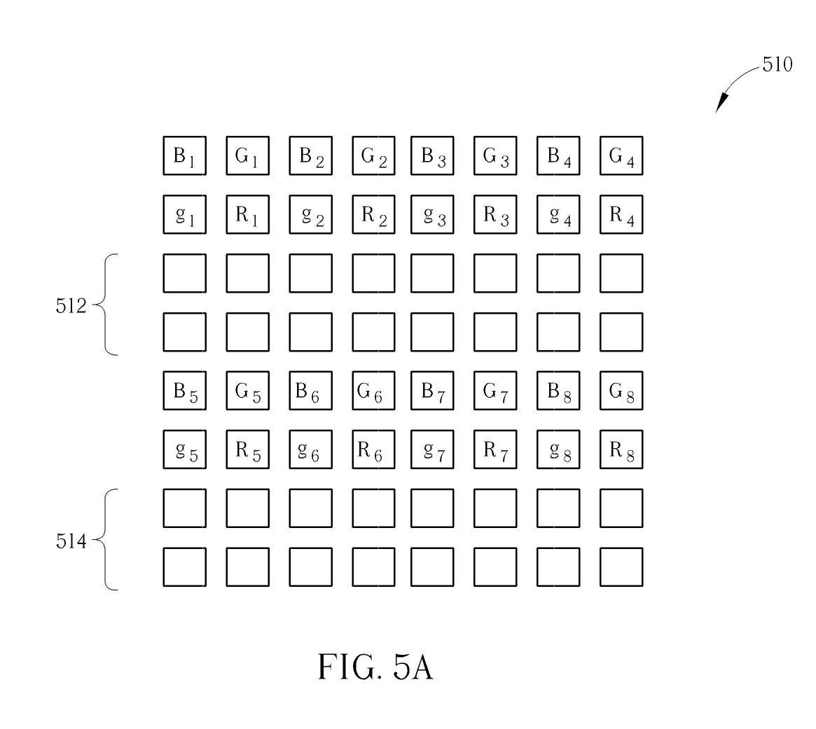

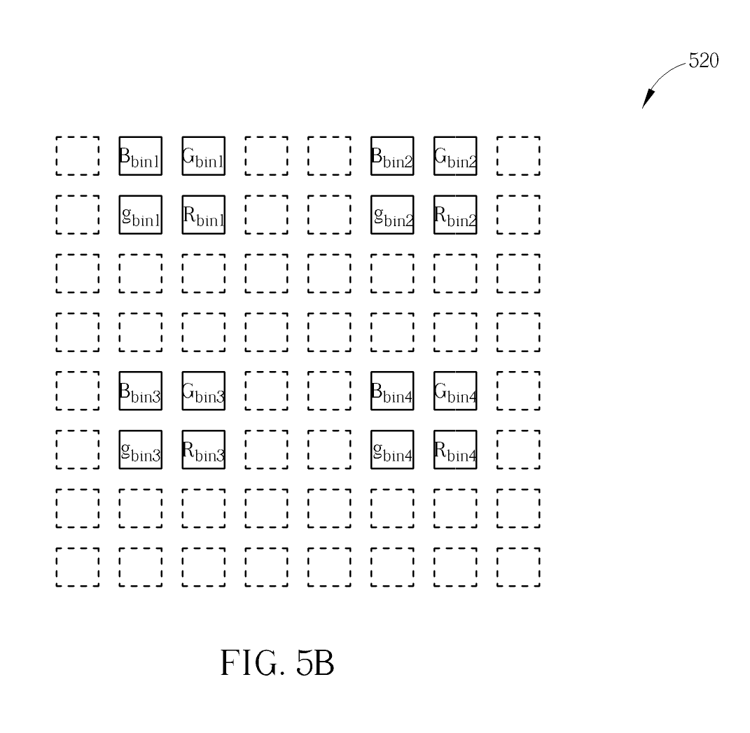

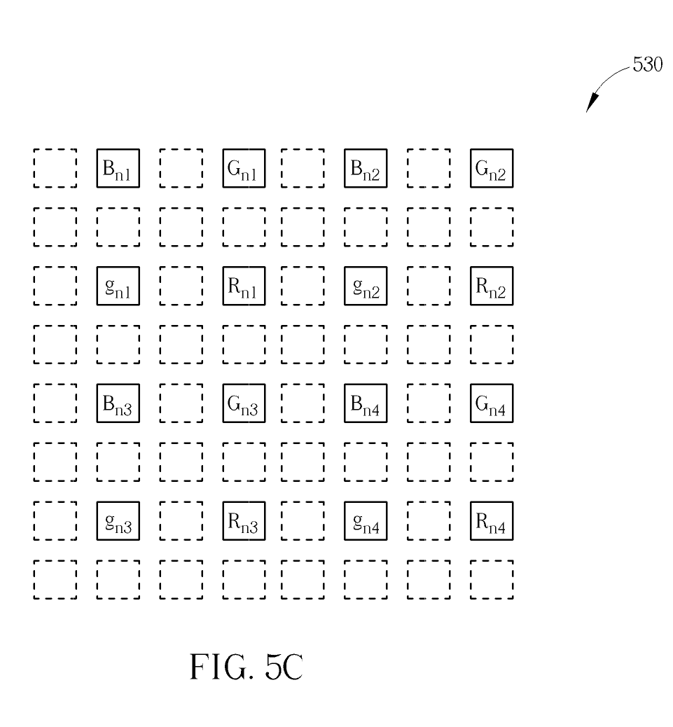

FIG. 4C is a diagram illustrating a re-sampled pixel block derived from the binned pixel block 420 shown in FIG. 5. The re-sampled pixel block 430 shown in FIG. 4C is a 4×4 pixel block which is generated by re-sampling the binned pixel block 420. Please note that the boxes with a dotted line are used for illustrative purposes only. In other words, the boxes with a dotted line are not pixels. The Bₙ₁, Gₙ₁, gₙ₁, and Rₙ₁ are the re-sampling pixels of the binning pixels B_{bin1}, G_{bin1}, g_{bin1}, and R_{bin1}, wherein the Bₙ₁ pixel, the Gₙ₁ pixel, and the gₙ₁ pixel are identical to the B_{bin1} pixel, the G_{bin1} pixel, and the g_{bin1} pixel, respectively; only the Rₙ₁ pixel is modified. The position of the Rₙ₁ pixel is the box with a dotted line at the lower right side around the R_{bin1} pixel, and therefore the relative pixel distances between the Rₙ₁ pixel and the Gₙ₃ pixel, the relative pixel distance between the Rₙ₁ pixel and the gₙ₁ pixel, the relative pixel distance between the gₙ₁ pixel and the Bₙ₁ pixel, and the relative pixel distance between the Gₙ₁ pixel and the Bₙ₁ pixel are equal to each other. However, the corresponding composition of Rₙ₁ at the position (i.e., the box with a dotted line at the lower right side around the R_{bin1} of the binned pixel block 420) includes R_{bn1}, R_{bn2}, R_{bn3}, and R_{bn4}, and thus the weighting factor might be set as 9/16, 3/16, 3/16, and 1/16 respectively due to the relative pixel distances between the Rₙ₁ pixel and the R_{bin1} pixel, between the Rₙ₁ pixel and the R_{bin2} pixel, between the Rₙ₁ pixel and the R_{bin3} pixel, and between the Rₙ₁ pixel and the R_{bin4} pixel. The summation of the weighting factors of R_{bin1}, R_{bin2}, R_{bin3}, and R_{bin4} should be 1 due to that the composition of Rₙ₁ contains only R_{bin1}, R_{bin2}, R_{bin3}, and R_{bin4}. It should be noted that the weighting factors could be adjusted according to the actual demand in practice, and the settings in this embodiment are for illustrative purposes only, and are not meant to be a limitation of the present invention. Modifications of the weighting factors also belong to the scope of the present invention.

FIGS. 5A-5C is a diagram illustrating a pixel block according to another embodiment of the present invention. The pixel block 510 shown in FIG. 5A is an 8×8 pixel block including 64 pixels belonging to 3 colors, blue (B), green (G), and red (R) according to the Bayer filter. FIG. 5B is a diagram illustrating a binned pixel block derived from the pixel block 510 shown in FIG. 5A. The binned pixel block 520 shown in FIG. 5B is a 4×4 pixel block which is generated by the pixel binning algorithm configured to perform vertical sub-sampling horizontal binning. Please note that the boxes with a dotted line are used for illustrative purposes. In other words, the boxes with a dotted line are not pixels due to the 8×8 pixel block 510 being reduced to the 4×4 block 520 after the vertical sub-sampling horizontal binning process. A pixel sub-block 512 and a pixel sub-block 514 are bypassed due to the sub-sampling horizontal binning, and the remaining pixels in the pixel block 510 would be used to generate the binned pixel block 520. The pixels in the binned pixel block 520 might be represented by the following equations:

B_{bin1}=(B₁+B₂)/2,

G_{bin1}=(G₁+G₂)/2,

g_{bin1}=(g₁+g₂)/2, and

R_{bin1}=(R₁+R₂)/2.

As other binned pixels in the binned pixel block 520 are generated according to the same rules like B_{bin1}, G_{bin1}, g_{bin1}, and R_{bin1}, the equations of other binned pixels in the binned pixel block 520 are omitted here for brevity. According the binned pixel block 520, four separated groups would introduce irregular arrangement to the binned image. To put it another way, the relative pixel distances are changed and the pixel distribution is not uniform after the vertical sub-sampling horizontal binning process. In order to get rid of the side effects and to improve the image quality, the G_{bin1} pixel, the R_{bin1} pixel, and the g_{bin1} pixel need to be moved to new places like the re-sampled pixel block shown FIG. 5C, thus ensuring the uniform distribution of the image. That is to say, when the binned image is generated by the pixel binning algorithm configured to perform vertical sub-sampling horizontal binning, the method includes selecting the binned pixels diagonally adjacent to each other for a same color; or selecting the binned pixels vertically adjacent to each other for the same color; or selecting the binned pixels, each vertically adjacent to one of the binned pixels for the same color, horizontally adjacent to another of the binned pixels for the same color, and diagonally adjacent to yet another of the binned pixels for the same color. The related operation may be expressed using the following equations:

$${B}_{n 1} = {B}_{bin 1} , \\ {G}_{n 1} = \frac{3}{4} {G}_{bin 1} + \frac{1}{4} {g}_{bin 2} , \\ {g}_{n 1} = \frac{3}{4} {g}_{bin 1} + \frac{1}{4} {g}_{bin 3} , and$$

$${R}_{n 1} = \frac{9}{16} {R}_{bin 1} + \frac{3}{16} {R}_{bin 2} + \frac{3}{16} {R}_{bin 3} + \frac{1}{16} {R}_{bin 4} .$$

FIG. 5C is a diagram illustrating a re-sampled pixel block derived from the binned pixel block 520 shown in FIG. 5B. The re-sampled pixel block 530 shown in FIG. 5C is a 4×4 pixel block which is generated by re-sampling the binned pixel block 520. Please note that the boxes with a dotted line are used for illustrative purposes only. In other words, the boxes with a dotted line are not pixels. The Bₙ₁, Gₙ₁, gₙ₁, and Rₙ₁ are the re-sampling pixels of the binning pixels B_{bin1}, G_{bin1}, g_{bin1}, and R_{bin1}, wherein the Bₙ₁ pixel is identical to the B_{bin1} pixel; however, the G_{bin1} pixel, the gₙ₁ pixel, and the Rₙ₁ pixel are modified. The position of the gₙ₁ pixel is the box with a dotted line right below the g_{bin1} pixel of the binned pixel block 520, and therefore the relative pixel distance between the gₙ₁ pixel and the Bₙ₃ pixel equals the relative pixel distance between the gₙ₁ pixel and the Bₙ₁ pixel. The position of the Gₙ₁ pixel is the box with a dotted line close to the right side of the g_{bin1} pixel of the binned pixel block 520, and therefore the relative pixel distance between the Gₙ₁ pixel and the Bₙ₂ pixel equals the relative pixel distance between the Gₙ₁ pixel and the Bₙ₁ pixel. The position of the Rₙ₁ pixel is the box with a dotted line at the lower right side around the R_{bin1} pixel, and therefore the relative pixel distance between the Rₙ₁ pixel and the Gₙ₁ pixel, the relative pixel distance between the Rₙ₁ pixel and the gₙ₁ pixel, the relative pixel distance between the Rₙ₁ pixel and the gₙ₂ pixel, and the relative pixel distance between the Rₙ₁ pixel and the Gₙ₃ pixel are equal to each other. However, the corresponding composition of gₙ₁ at the position (i.e., the box with a dotted line right below the g_{bin1} pixel of the binned pixel block 320) includes both g_{bn1} and g_{bn3}, and the weighting factor should be ¾ and ¼ respectively due to the relative pixel distance between the gₙ₁ pixel and the g_{bin3} pixel is 3 times as large as the relative pixel distance between the gₙ₁ pixel and the g_{bin1} pixel. That is, the weighting factor of the g_{bin1} pixel should be 3 times as large as the weighting factor of the g_{bin3} pixel. As settings of other weighting factors can be easily deduced by analogy, further description is omitted here for brevity. It should be noted that the weighting factors could be adjusted according to the actual demand in practice, and the settings in this embodiment are for illustrative purposes only, and are not meant to be limitations of the present invention. Modifications on the weighting factors also belong to the scope of the present invention.

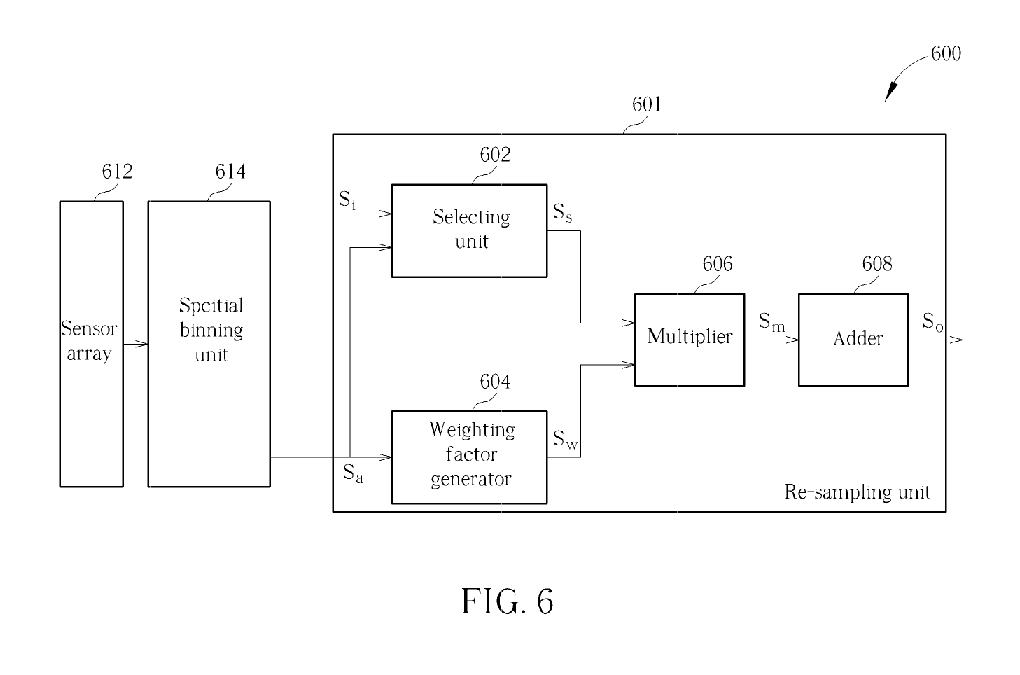

FIG. 6 is a block diagram illustrating a spatial binning circuit 430 according to an embodiment of the invention. The spatial binning circuit 430 includes a sensor array 612, a spatial binning circuit 614, and a re-sampling unit 601. The sensor array 612 equipped in the spatial binning circuit 430 is used to receive a raw image for the spatial binning circuit 614 which will perform the pixel binning process upon the raw image by the binning unit, to generate an input pixels Sᵢ and a pixel binning algorithm Sₐ for the re-sampling unit 601.

The re-sampling unit 601 includes a selecting unit 602, a weighting factor generator 604, a multiplier 606, and an adder 608. The selecting unit 602 is arranged for selecting binned pixels Sₛ from the input pixels Sᵢ of an image according to the pixel binning algorithm Sₐ adopted for generating the image. The weighting factor generator 604 is arranged for determining weighting factors S_{w} according to the pixel binning algorithm Sₐ adopted for generating the image. The multiplier 606 is arranged for multiplying a plurality of binned pixels Sₛ of the image with a plurality of weighting factors S_{w} to generate a plurality of weighted pixels Sₘ, respectively. The adder 608 is arranged for summing up the weighted pixels Sₘ to generate a re-sampled pixel Sₒ. Specifically, the spatial binning circuit 430 is devised to perform the above-mentioned spatial binning method. As a person skilled in the art can readily understand details of the spatial binning circuit 430 after reading above paragraphs, further description is omitted here for brevity.

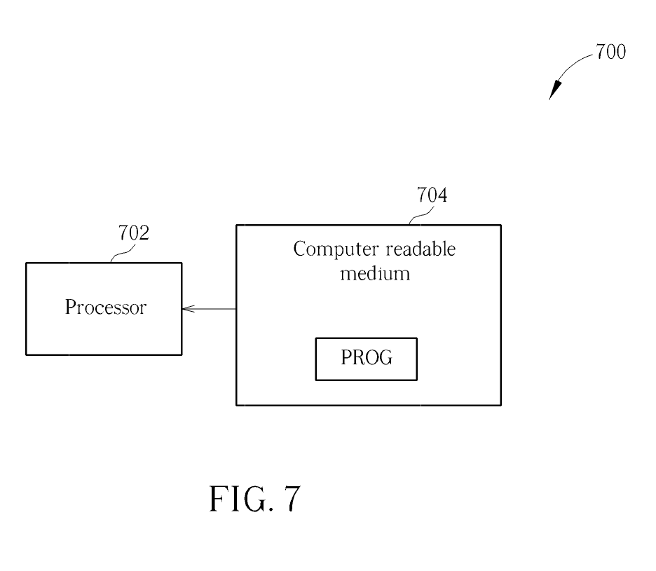

Regarding the spatial binning circuit 430 shown in FIG. 6, a hardware-based implementation is employed. More specifically, the sensor array 612, the spatial binning unit 614, the selecting unit 602, the weighting factor generator 604, the multiplier 606, and the adder 608 are hardware elements. However, using a software-based implementation to realize a spatial binning circuit is also feasible. Please refer to FIG. 7, which is a block diagram illustrating a spatial binning circuit 510 according to a second embodiment of the present invention. The spatial binning circuit 510 includes a processor 702 and a computer readable medium 704. For example, the processor 702 may be a central processing unit (CPU) or a micro control unit (MCU), and the computer readable medium 704 may be a non-transitory storage device (e.g., a flash memory or a dynamic random access memory). The computer readable medium 704 has a program code PROG stored therein. When executed by the processor 702, the program code PROG enables the processor 702 to perform steps of the above-mentioned spatial binning method 100 shown in FIG. 1. The same objective of obtaining a re-sampled pixel block (e.g., 230, 330, 430 or 530) from processing a binned pixel block is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A spatial binning method, comprising:
receiving a raw image;
pixel binning the raw image to generate a binned image; and
re-sampling the binned image spatially to generate a re-sampled image according to the values and positions of the pixels of the binned image.

2. The spatial binning method of claim 1, wherein the step of re-sampling the binned image spatially to generate a re-sampled image according to the values and positions of the pixels of the binned image comprises:
utilizing a multiplication circuit for multiplying a plurality of binned pixels of the binned image with a plurality of weighting factors to generate a plurality of weighted pixels, respectively; and
summing up the weighted pixels to generate a re-sampled pixel.

3. The spatial binning method of claim 2, further comprising:
selecting the binned pixels from the binned image according to a pixel binning algorithm adopted for generating the image.

4. The spatial binning method of claim 3, wherein the step of selecting the binned pixels from the binned image comprises:
when the binned image is generated by the pixel binning algorithm configured to perform vertical binning and horizontal binning, selecting the binned pixels diagonally adjacent to each other for a same color.

5. The spatial binning method of claim 3, wherein the step of selecting the binned pixels from the binned image comprises:
when the binned image is generated by the pixel binning algorithm configured to perform vertical binning without horizontal binning, selecting the binned pixels vertically adjacent to each other for a same color.

6. The spatial binning method of claim 3, wherein the step of selecting the binned pixels from the image comprises:
when the binned image is generated by the pixel binning algorithm configured to perform diamond-shape binning, selecting the binned pixels, each vertically adjacent to one of the binned pixels for a same color, horizontally adjacent to another of the binned pixels for the same color, and diagonally adjacent to yet another of the binned pixels for the same color.

7. The spatial binning method of claim 3, wherein the step of selecting the binned pixels from the image comprises:
when the binned image is generated by the pixel binning algorithm configured to perform vertical sub-sampling horizontal binning:
selecting the binned pixels diagonally adjacent to each other for a same color; or
selecting the binned pixels vertically adjacent to each other for the same color; or
selecting the binned pixels, each vertically adjacent to one of the binned pixels for the same color, horizontally adjacent to another of the binned pixels for the same color, and diagonally adjacent to yet another of the binned pixels for the same color.

8. The spatial binning method of claim 2, further comprising:
determining the weighting factors according to a pixel binning algorithm adopted for generating the image.

9. The spatial binning method of claim 8, wherein the step of determining the weighting factors comprises:
when the binned image is generated by the pixel binning algorithm configured to perform vertical binning and horizontal binning, setting the weighting factors to 5/4 and −¼, respectively.

10. The spatial binning method of claim 8, wherein the step of determining the weighting factors comprises:
when the binned image is generated by the pixel binning algorithm configured to perform vertical binning without horizontal binning, setting the weighting factors to ¾ and ¼, respectively.

11. The spatial binning method of claim 8, wherein the step of determining the weighting factors comprises:
when the binned image is generated by the pixel binning algorithm configured to perform diamond-shape binning, setting the weighting factors to 9/16, 3/16, 3/16, and 1/16, respectively.

12. The spatial binning method in claim 8, wherein the step of determining the weighting factors comprises:
when the binned image is generated by the pixel binning algorithm configured to perform vertical sub-sampling horizontal binning:
setting the weighting factors to ¾ and ¼, respectively; or
setting the weighting factors to 9/16, 3/16, 3/16, and 1/16, respectively.

13. A spatial binning circuit, comprising:
a binning unit for receiving a raw image to generate a binned image; and
a re-sampling unit for receiving the binned image and re-sampling the pixels of the binned image according to the values and positions of the pixels of the binned image.

14. The spatial binning circuit of claim 13, wherein the re-sampling unit comprises:
a multiplier, arranged for multiplying a plurality of binned pixels of the binned image with a plurality of weighting factors to generate a plurality of weighted pixels, respectively; and
an adder, arranged for summing up the weighted pixels to generate a re-sampled pixel.

15. The spatial binning circuit of claim 14, further comprising:
a selecting unit, arranged for selecting the binned pixels from the binned image according to a pixel binning algorithm adopted for generating the image.

16. The spatial binning circuit of claim 15, wherein when the binned image is generated by the pixel binning algorithm configured to perform vertical binning and horizontal binning, the selecting unit selects the binned pixels diagonally adjacent to each other for a same color.

17. The spatial binning circuit of claim 1 5, wherein when the binned image is generated by the pixel binning algorithm configured to perform vertical binning without horizontal binning, the selecting unit selects the binned pixels vertically adjacent to each other for a same color.

18. The spatial binning circuit of claim 1 5, wherein when the binned image is generated by the pixel binning algorithm configured to perform diamond-shape binning, the selecting unit selects the binned pixels, each vertically adjacent to one of the binned pixels for a same color, horizontally adjacent to another of the binned pixels for the same color, and diagonally adjacent to yet another of the binned pixels for the same color.

19. The spatial binning circuit of claim 1 5, wherein when the binned image is generated by the pixel binning algorithm configured to perform vertical sub-sampling horizontal binning, the selecting unit:
selects the binned pixels diagonally adjacent to each other for a same color; or
selects the binned pixels vertically adjacent to each other for the same color; or
selects the binned pixels, each vertically adjacent to one of the binned pixels for the same color, horizontally adjacent to another of the binned pixels for the same color, and diagonally adjacent to yet another of the binned pixels for the same color.

20. The spatial binning circuit of claim 14, further comprising:
a weighting factor generator, arranged for determining the weighting factors according to a pixel binning algorithm adopted for generating the image.

21. The spatial binning circuit of claim 20, wherein when the binned image is generated by the pixel binning algorithm configured to perform vertical binning and horizontal binning, the weighting factor generator sets the weighting factors to 5/4 and −¼, respectively.

22. The spatial binning circuit of claim 20, wherein when the binned image is generated by the pixel binning algorithm configured to perform vertical binning without horizontal binning, the weighting factor generator sets the weighting factors to ¾ and ¼, respectively.

23. The spatial binning circuit of claim 20, wherein when the binned image is generated by the pixel binning algorithm configured to perform diamond-shape binning, the weighting factor generator sets the weighting factors to 9/16, 3/16, 3/16, and 1/16, respectively.

24. The spatial binning circuit of claim 20, wherein when the binned image is generated by the pixel binning algorithm configured to perform vertical sub-sampling horizontal binning, the weighting factor generator:
sets the weighting factors to ¾ and ¼, respectively; or
sets the weighting factors to 9/16, 3/16, 3/16, and 1/16, respectively.

25. A non-transitory computer readable medium, storing a program code, wherein when executed by a processor, the program code enables the processor to perform following steps for spatial binning
pixel binning a raw image to generate a binned image; and
re-sampling the binned image spatially to generate a re-sampled image according to the values and positions of the pixels of the binned image.
